(19) United States
(12) Patent Application Publication
(10) Pub. No.: US 2013/0169064 A1
(43) Pub. Date: Jul. 4, 2013

(54) ENERGY STORAGE SYSTEM AND CONTROLLING METHOD OF THE SAME

(71) Applicants: Jong-Ho Park, Yongin-si (KR); Jong-Ki Choi, Yongin-si (KR)

(72) Inventors: Jong-Ho Park, Yongin-si (KR); Jong-Ki Choi, Yongin-si (KR)

(73) Assignee: Samsung SDI Co., Ltd., Yongin-si, Gyeonggi-do, (KR)

(21) Appl. No.: 13/820,948

(22) PCT Filed: Oct. 28, 2010
(86) PCT No.: PCT/KR10/07438

§ 371 Date: Mar. 5, 2013

Related U.S. Application Data
(60) Provisional application No. 61/381,741, filed on Sep. 10, 2010.

(51) Int. Cl. H02J 3/28

(52) U.S. Cl. CPC H02J 3/28
USPC 307/112

(57) ABSTRACT

An energy storage system constructed with a power conversion system that transmits and receives electric power respectively to and from, an external power grid and to apply the electric power received from the external power grid to an electric load via a first path, and a bypass switch shunt coupled with the power conversion system to provide a second and different path to apply power received from the external power grid to the electric load.

### TECHNICAL FIELD

The present invention relates to an energy storage system and a method of controlling the same.

### BACKGROUND ART

Due to problems such as environmental destruction and exhaustion of natural resources, interest in a system for storing power and efficiently utilizing the stored power is increasing and interest in new renewable energy sources that do not cause pollution as a by-product of the generation of power is also increasing. An energy storage system is a system for associating new sources of renewable energy, power stored in batteries, and power on a typical electrical power grid, and is currently a subject of active research and development as a remedy to current environment variations.

### DISCLOSURE OF INVENTION

### Technical Problem)

One or more embodiments of the present invention include an energy storage system capable of stably supplying power to a load and a method of controlling the energy storage system.

### Solution to Problem

One embodiment of an energy storage system may be constructed with a power conversion system that regulates distribution of electrical power from a local power generating system and a multi-customer electrical power distribution grid, with each of the local power generating system and the power distribution grid individually coupled to different terminals of the power conversion system. A battery based storage unit is separately coupled to the power conversion system, between the electrical power grid and the battery based storage unit. An electrically driven load may be coupled to the energy storage system to driven by electrical power received from the power conversion system.

The electrically driven load may be coupled to the energy storage system to driven by electrical power received from the power conversion system in conformance with the ability of the electrical power grid to supply electrical power to the power conversion system, the ability of the power generation system to supply electrical power to the power conversion system, the consumption of electrical power by the load, the characteristics exhibited by the storage battery, and time.

A switching stage may be shunt coupled with the power conversion system to form a bypass enabling transmission of electrical power between the grid and the load.

According to embodiments of the present invention, an energy storage system is capable of stably supplying power to a load even during instances when the energy storage system fails to operate normally, and a method of controlling the energy storage system may be provided.

According to one aspect of the present invention, there is provided an energy storage system that includes a power conversion system to transmit and receive electric power to and from an external power grid and to relay said electric power received from said external power grid to an electric load via a first path and a bypass switch arranged to provide a second and different path to relay power received from said external power grid to said electric load. The bypass switch may be arranged in parallel to said power conversion system. The power conversion system may include a first switch along said first path, said received electric power being relayed to said electric load via said second path when said first switch blocks said first path. The power conversion system may include an integrated controller to monitor operational states of the power conversion system, the integrated controller to control ON and OFF states of the bypass switch based on the monitored operational states. The bypass switch may instead be a manual switch. The power conversion system may include an integrated controller to monitor operational states of the power conversion system, the integrated controller to alternately place the first switch in an ON state while the bypass switch is in an OFF state, and to place the first switch in an OFF state while the bypass switch is in an ON state based on the monitored operational states.

The bypass switch may be arranged in series with the power conversion system and may be a path changing circuit adapted to transmit power received from said external power grid along said first path or said second path based on an operational state of the first switch. When the bypass switch does not receive any signal from the integrated controller, the bypass switch may revert to an ON state. The external power grid may include a switchboard and a circuit breaker between the switchboard and the electric load, said bypass switch and said power conversion system may be coupled in parallel between the circuit breaker and the electric load. The electric load may include a switchboard and a circuit breaker between the switchboard and the external power grid, said bypass switch and said power conversion system being coupled in parallel between the switchboard and the external power grid.

### Advantageous Effects of Invention

According to embodiments of the present invention, an energy storage system capable of stably supplying power to a load even if the energy storage system does not operate normally, and a method of controlling the energy storage system may be provided.

### BRIEF DESCRIPTION OF DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of an energy storage system according to a first embodiment of the present invention;

FIG. 2 is a diagram for describing a process for operating the energy storage system illustrated in FIG. 1, according to the first embodiment of the present invention;

FIG. 3 is a diagram for describing a process for operating the energy storage system illustrated in FIG. 1, according to the first embodiment of the present invention;

FIG. 4 is a flowchart illustrating a process for operating the energy storage system illustrated in FIG. 1, according to the first embodiment of the present invention;

FIG. 5 is a block diagram of an energy storage system according to a second embodiment of the present invention;

FIG. 6 is a diagram for describing a process for operating the energy storage system illustrated in FIG. 5, according to the second embodiment of the present invention;

FIG. 7 is a diagram for describing a process for operating the energy storage system illustrated in FIG. 5, according to the second embodiment of the present invention;

FIG. 8 is a flowchart illustrating a process for operating the energy storage system illustrated in FIG. 5, according to the second embodiment of the present invention;

FIG. 9 is a block diagram of an energy storage system according to a third embodiment of the present invention;

FIG. 10 is a diagram for describing a process for operating the energy storage system illustrated in FIG. 9, according to the third embodiment of the present invention;

FIG. 11 is a diagram for describing a process for operating the energy storage system illustrated in FIG. 9, according to the third embodiment of the present invention; and

FIG. 12 is a flowchart illustrating a process for operating the energy storage system illustrated in FIG. 9, according to the third embodiment of the present invention.

### BEST MODE FOR CARRYING OUT THE INVENTION

According to one aspect of the present invention, there is provided an energy storage system that includes a power conversion system to transmit and receive electric power to and from an external power grid and to relay said electric power received from said external power grid to an electric load via a first path and a bypass switch arranged to provide a second and different path to relay power received from said external power grid to said electric load.

### Mode for the Invention

This application makes reference to, incorporates the same herein, and claims all benefits accruing under 35 U.S.C. '119 from an application earlier filed in the U.S. Patent and Trademark Office on the 10 of Sep. 2010 and there duly assigned Ser. No. 61/381,741.

While exemplary embodiments of the invention are susceptible to various modifications and alternative forms, specific embodiments thereof are shown by way of example in the drawings and will herein be described in detail. It should be understood, however, that there is no intent to limit exemplary embodiments of the invention to the particular forms disclosed, but conversely, exemplary embodiments of the invention are to cover all modifications, equivalents, and alternatives falling within the spirit and scope of the invention.

In the following description of the present invention, a detailed description of known functions and configurations incorporated herein will be omitted when the inclusion may make an understanding of the subject matter of the present invention unclear.

Hereinafter, the present invention will be described in detail by explaining embodiments of the invention with reference to the attached drawings. Like reference numerals in the drawings denote like elements and thus repeated descriptions will be omitted.

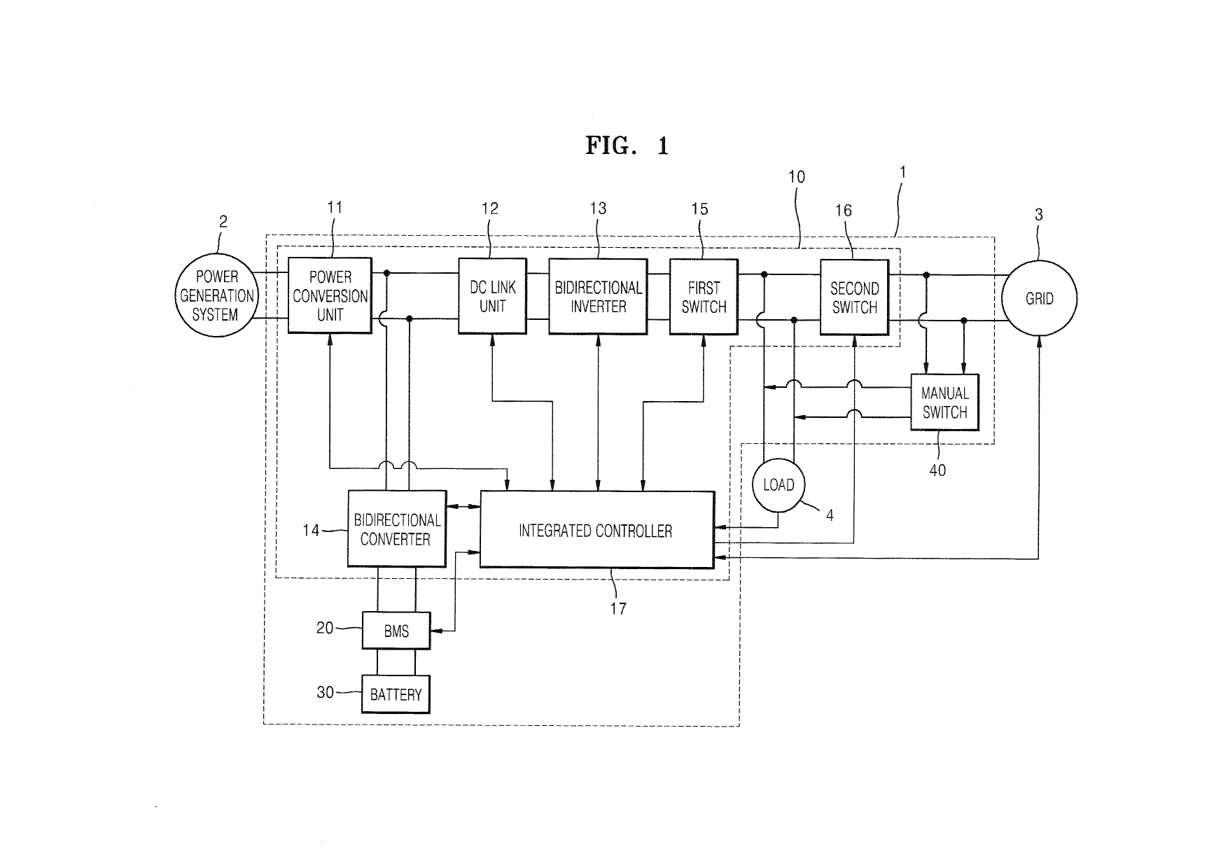

Turning now to FIG. 1, FIG. 1 is a block diagram of an energy storage system 1 according to a first embodiment of the present invention. Referring to FIG. 1, the energy storage system 1 supplies power to load 4 in association with a power generation system 2 and an electrical transmission grid 3.

The power generation system 2 generates power by using an energy source. The power generation system 2 supplies the generated power to the energy storage system 1. The power generation system 2 may be a solar photovoltaic system, a wind turbine system, or a tidal turbine system, and may include other power generation systems for generating power by using new sources of renewable energy, such as, solar energy or geothermal energy. In particular, solar batteries for generating electric energy by using sunlight may be easily installed in houses or factories and thus may be appropriately used as the energy storage system 1 used in a house. Alternatively, power generation system 2 may include a plurality of power generation modules that are electrically coupled in parallel, may generate electrical power by using each of the power generation modules, and thus may form a large capacity electrical energy system.

The grid 3 includes a power plant, a substation, power transmission cables, and other components for the generation, transmission and distribution of electrical power. When grid 3 operates normally, the grid 3 supplies electrical power to the energy storage system 1 in order to supply electrical power to the load 4 and/or battery 30, and receives power from the energy storage system 1. When grid 3 operates in an abnormally, power supplied from grid 3 to energy storage system 1 is stopped and power supplied by the energy storage system 1 to grid 3 is also stopped.

The load 4 consumes power generated by the power generation system 2, power stored in the battery 30, or power supplied from the grid 3. A house or a factory may be an example of a load 4.

The energy storage system 1 may store power generated by the power generation system 2 in the battery 30, and may supply the generated power to the grid 3. Also, the energy storage system 1 may supply power stored in the battery 30 to the grid 3, or may store power supplied from the grid 3 in the battery 30. Also, if the grid 3 has an error, e.g., if the grid 3 is blacked out, the energy storage system 1 may supply power to the load 4 by performing an uninterruptible power supply (UPS) operation. When the grid 3 operates normally, the power generation system 2 may supply the generated power or the power stored in the battery 30 to the load 4.

The energy storage system 1 includes a power conversion system (PCS) 10 for controlling power conversion, a battery management system (BMS) 20, the battery 30, and a manual switch 40.

The PCS 10 converts power from the power generation system 2, the grid 3, and the battery 30 into appropriate power and supplies the converted power to where it is required. The PCS 10 includes a power conversion unit 11, a direct current (DC) link unit 12, a bidirectional inverter 13, a bidirectional converter 14, a first switch 15, a second switch 16, and an integrated controller 17.

The power conversion unit 11 is connected between the power generation system 2 and the DC link unit 12. The power conversion unit 11 transfers power generated by the power generation system 2 to the DC link unit 12 and, in this case, the power conversion unit 11 converts its output voltage into a DC link voltage.

The power conversion unit 11 may include a converter, a rectification circuit, or the like according to the type of the power generation system 2. That is, if the power generation system 2 generates DC power, the power conversion unit 11 may be a converter for converting DC power into DC power. On the other hand, if the power generation system 2 generates alternating current (AC) power, the power conversion unit 11 may be a rectification circuit for converting AC power into DC power. In particular, the power generation system 2 uses sunlight to generate power, the power conversion unit 11 may include a maximum power point tracking (MPPT) converter for performing MPPT control to maximize power generated by the power generation system 2 according to, for example, variations in insolation and temperature. The power conversion unit 11 may stop operating if the power generation system 2 does not generate power, and thus may minimize power consumed by the converter and the like.

The DC link unit 12 is connected between the power conversion unit 11 and the bidirectional inverter 13 to constantly maintain a DC link voltage. The DC link voltage may have an unstable size due to an instantaneous voltage sag of the power generation system 2 or the grid 3, a peak load of the load 4, or the like, and has to be stable to normally operate the bidirectional converter 14 and the bidirectional inverter 13. The DC link unit 12 may be used to stabilize the DC link voltage and may be, for example, a large capacity capacitor. Although the DC link unit 12 is separately illustrated in FIG. 1, the DC link unit 12 may be included in the power conversion unit 11, the bidirectional inverter 13, or the bidirectional converter 14.

The bidirectional inverter 13 is a power converter connected between the DC link unit 12 and the first switch 15. In a discharge mode, the bidirectional inverter 13 converts a DC link voltage output from the power generation system 2 and/or the battery 30, into an AC voltage for the grid 3 and outputs the converted AC voltage. On the other hand, in a charge mode, the bidirectional inverter 13 rectifies and converts an AC voltage of the grid 3 into a DC link voltage, and outputs the converted DC link voltage in order to store power from the grid 3 in the battery 30.

The bidirectional inverter 13 may include a filter for removing harmonics from an AC voltage output to the grid 3. Also, the bidirectional inverter 13 may include a phase locked loop (PLL) circuit for synchronizing the phase of an AC voltage output from the bidirectional inverter 13 with the phase of an AC voltage of the grid 3, in order to suppress generation of invalid power. In addition, the bidirectional inverter 13 may perform functions such as voltage variation range restriction, power factor improvement, DC component removal, and transient phenomenon prevention.

If the bidirectional inverter 13 does not need to supply power generated by the power generation system 2 or power stored in the battery 30, to either the load 4 or the grid 3, or if power from the grid 3 is not needed to charge the battery 30, the bidirectional inverter 13 may stop operating to minimize power consumption.

In the discharge mode, the bidirectional converter 14 DC DC converts power stored in the battery 30, into a voltage level required by the bidirectional inverter 13, i.e., a DC link voltage, and outputs the converted power. On the other hand, in the charge mode, the bidirectional converter 14 DC DC converts power output from the power conversion unit 11 or the bidirectional inverter 13, into a voltage level required by the battery 30, i.e., a charge voltage. If the battery 30 does not need to be charged or discharged, the bidirectional converter 14 may stop operating to minimize power consumption.

The first switch 15 and the second switch 16 are connected in series between the bidirectional inverter 13 and the grid 3, and control the flow of a current between the power generation system 2 and the grid 3 by performing on and off operations under the control of the integrated controller 17. The first switch 15 and the second switch 16 may be switched on or off according to states of the power generation system 2, the grid 3, and the battery 30. Operation of the first switch 15 and the second switch 16 will now be described in detail. However, the following descriptions are exemplarily provided and their operations are not limited thereto.

If power of the power generation system 2 and/or the battery 30 is supplied to the load 4, the first switch 15 is switched on. In this case, if power of the grid 3 is also supplied to the load 4, the second switch 16 may also be switched on. Otherwise, the second switch 16 may be switched off.

If power of the power generation system 2 and/or the battery 30 is sold to the grid 3, or if power of the grid 3 charges the battery 30, the first switch 15 and the second switch 16 are switched on.

If only power of the grid 3 is supplied to the load 4, the second switch 16 is switched on. In this case, if the battery 30 needs to be charged, the first switch 15 may also be switched on. Otherwise, the first switch 15 may be switched off. For example, the above operation may be performed when power of the grid 3 is inexpensive, e.g., off-peak electricity.

Meanwhile, if the grid 3 is blacked out, the second switch 16 is switched off and the first switch 15 is switched on. As such, power from either the power generation system 2 or the battery 30 may be supplied to the load 4, and an accident by a worker who works near a power line of the grid 3, e.g., an electric shock, may be prevented by not allowing power supplied to the load 4 to flow toward the grid 3, i.e., by preventing a sole operation.

*48The integrated controller 17 monitors operational states of the power generation system 2, the grid 3, the battery 30, and the load 4, and controls the power conversion unit 11, the bidirectional inverter 13, the bidirectional converter 14, the first switch 15, the second switch 16, and the BMS 20 according to the result of monitoring. For example, the integrated controller 17 may monitor whether the grid 3 is blacked out and whether the power generation system 2 generates power. Also, the integrated controller 17 may monitor the amount of power generated by the power generation system 2, a charge state of the battery 30, the amount of power consumption of the load 4, and time.

Also, if the grid 3 is blacked out and thus the energy storage system 1 functions as a UPS, the integrated controller 17 may control the load 4 to supply power to a device having a priority in power supply from among a plurality of devices included in the load 4. For example, if the energy storage system 1 is installed at a house, the integrated controller 17 may control the load 4 to preferentially supply power to a refrigerator.

The integrated controller 17 may include a communication unit (not shown) for monitoring and controlling the power generation system 2, the grid 3, and the load 4 as described above, and may transmit and receive various types of data via the communication unit.

The BMS 20 is connected to the battery 30 and controls charge and discharge operations of the battery 30 under the control of the integrated controller 17. The BMS 20 may perform, for example, over charge protection, over discharge protection, over current protection, over voltage protection, over heating protection, and cell balancing in order to protect the battery 30. For this, the BMS 20 may monitor, for example, a voltage, a current, a temperature, a remaining amount of residual power, a lifetime, and a charge state of the battery 30, and may transmit these results of monitoring to the integrated controller 17.

The battery 30 receives and stores power generated by the power generation system 2 or power of the grid 3, and supplies the stored power to the load 4 or the grid 3.

The battery 30 may include one or more battery racks connected in series and/or in parallel, and each of the battery racks may include one or more battery trays connected in series and/or in parallel. Also each of the battery trays may include a plurality of battery cells. The battery 30 may be one of various types of batteries such as a nickel cadmium (Ni Cd) battery, a lead (Pb) storage battery, a nickel metal hydride (NiMH) battery, a lithium (Li) ion battery, and an Li polymer battery. The number of battery racks included in the battery 30 may be determined according to, for example, a power capacity and a design condition required by the energy storage system 1. For example, the battery 30 may include a plurality of battery racks if the load 4 consumes a larger amount of power, and the battery 30 may include only one battery rack if the load 4 consumes a small amount of power.

Meanwhile, when the power generation system 2 generates surplus power, or when power can be supplied from grid 3, a determination may be made by integrated controller 17 as to whether to charge the battery 30 according to a state of charge (SOC) of the battery 30. In this case, a reference value or condition may be used to determine whether to charge the battery 30 and that reference may vary according to a setup of the energy storage system 1. For example, if an uninterruptible power supply (UPS) operation is regarded as important, as much power as possible needs to be stored in the battery 30. Accordingly, the energy storage system 1 may be set to charge the battery 30 whenever the battery 30 is not fully charged. Otherwise, if a long lifetime of the battery 30 is regarded as important, the energy storage system 1 may be set not to charge the battery 30 as long so the battery 30 is not fully discharged.

Meanwhile, if the battery 30 is hierarchically formed, the BMS 20 may be included for each layer of the battery 30. For example, if the battery 30 is hierarchically formed in an order of battery cells—>battery trays—>battery racks—>battery as describe above, the BMS 20 may include a plurality of tray BMSs for individually controlling a plurality of battery trays, a plurality of rack BMSs for controlling the tray BMS, and a system or master BMS for controlling the rack BMSs.

The manual switch 40 allows or blocks power supplied from the grid 3 to the load 4. The manual switch 40 is connected in parallel to the second switch 16 to allow power to be supplied from the grid 3 to the load 4 via the second switch 16 or the manual switch 40. When the PCS 10 operates normally, the manual switch 40 is switched off so that power from the grid 3 is supplied to the load 4 via the second switch 16. However, when the PCS 10 does not operate normally while the grid 3, the PCS 10 and the load 4 are connected in series, power of the grid 3 may not be supplied to the load 4. Accordingly, in this case, a user or a manager may manually switch to an on state the manual switch 40 so that power from the grid 3 can be supplied to the load 4. As described above, the manual switch 40 is a physical switch that is physically switched on or off by a person.

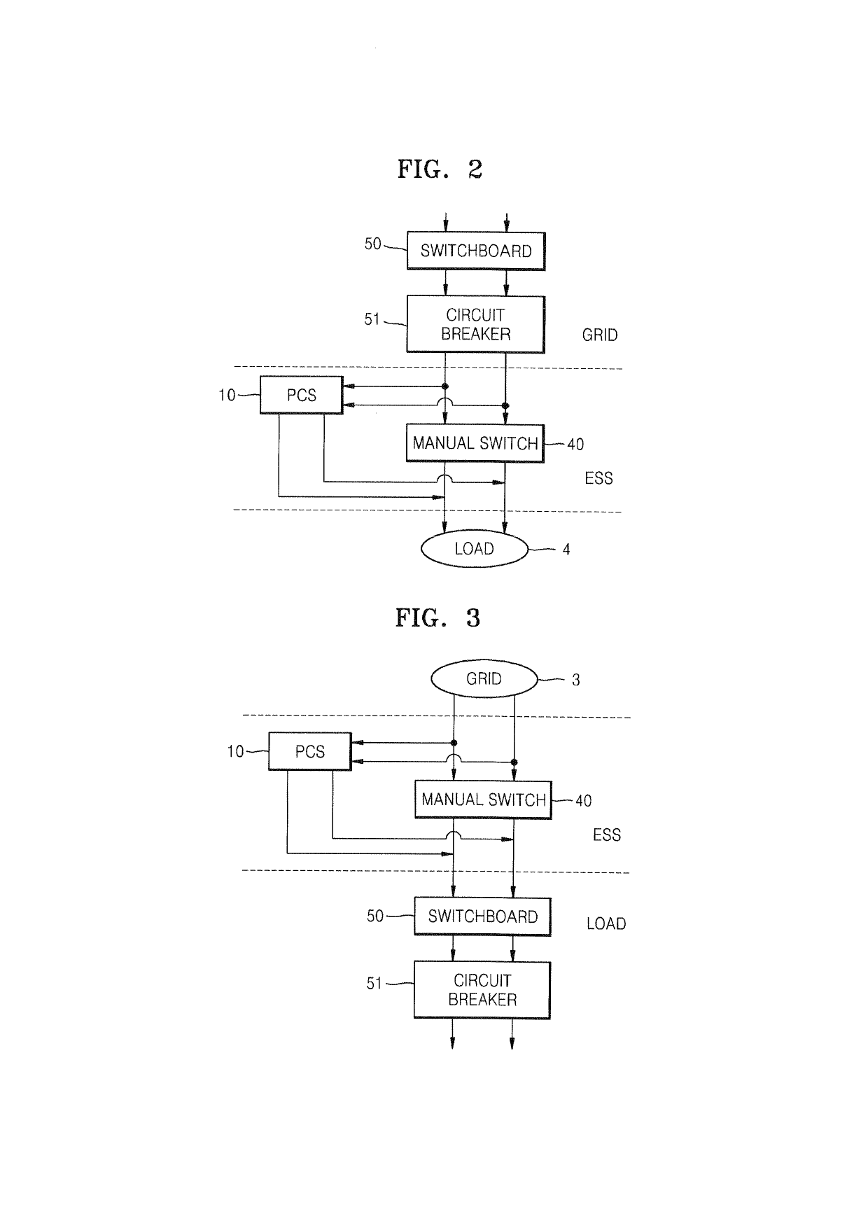

Turning now to FIG. 2, FIG. 2 is a diagram for describing a power supply method for the energy storage system 1 illustrated in FIG. 1, according to the first embodiment of the present invention. Referring to FIG. 2, the PCS 10 and the manual switch 40 are connected in parallel and are arranged between circuit breaker 51 and load 4. In FIG. 2, the PCS 10 and the manual switch 40 are located serially subsequent to a switchboard 50 and a circuit breaker 51. Here, the switchboard 50 and the circuit breaker 51 are included in the grid 3. The switchboard 50 distributes power supplied from a power generation station to a plurality of the loads 4 via various paths. The circuit breaker 51 senses the amount of power output from the switchboard 50 to be supplied to each of these loads 4, and blocks (i.e., opens the corresponding path of electrical power distribution) a power supply path when power equal to or greater than a previously set power amount, i.e., rated power, is supplied to the load 4 corresponding to that path.

Power passed through the circuit breaker 51 is commonly applied to the PCS 10 and the manual switch 40. When the PCS 10 operates normally however, power output from the PCS 10 is supplied to the load 4. On the other hand, when the PCS 10 is broken and thus does not operate normally, power output from the manual switch 40 is supplied to the load 4. In this case, a user or a manager has to recognize the break-down of the PCS 10 and then switch to an ON (i.e., to an electrically conducting) state the manual switch 40.

Turning now to FIG. 3, FIG. 3 is a diagram for describing a power supply method for the energy storage system 1 illustrated in FIG. 1, according to the first embodiment to of the present invention. Referring to FIG. 3, the PCS 10 and the manual switch 40 are also connected in parallel and are arranged between the switchboard 50 and the grid. In FIG. 3, the PCS 10 and the manual switch 40 are located in series with switchboard 50 and the circuit breaker 51. Here, the switchboard 50 and the circuit breaker 51 are included in the load 4.

Power supplied from the grid 3 is commonly applied to the PCS 10 and the manual switch 40. When the PCS 10 operates normally however, power output from the PCS 10 is supplied to the load 4. On the other hand, when the PCS 10 is broken and thus does not operate normally to enable distribution of electrical power grid 3 through switchboard 50 and circuit breaker 51, power output from the manual switch 40 is supplied to the load 4. In this case, a user or a manager has to recognize the break-down of the PCS 10 to switch manual switch 40 to an electrically conducting ON state.

Power output from the PCS 10 or the manual switch 40 is sequentially applied to the switchboard 50 and the circuit breaker 51 included in the load 4, and power output from the circuit breaker 51 is ultimately supplied to drive the load 4.

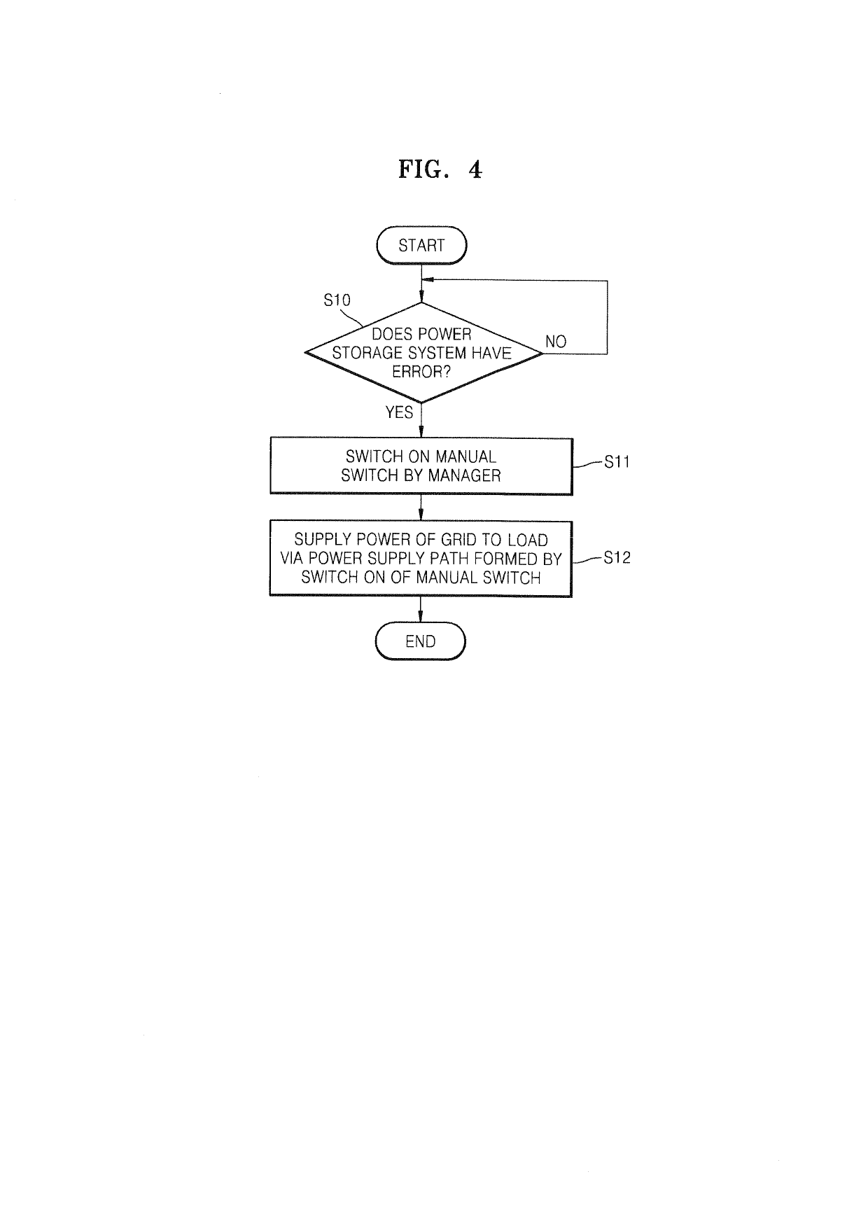

Turning now to FIG. 4, FIG. 4 is a flowchart of a power supply method of the energy storage system 1 illustrated in FIG. 1, according to a first embodiment of the present invention. Referring to FIG. 4, the energy storage system 1 supplies power from the grid 3 to drive the load 4. Then, energy storage system 1 makes a determination in real time whether the energy storage system 1 has experienced an error (operation S10).

If the energy storage system 1 has not suffered an error, the energy storage system 1 continuously supplies required power to the load 4 by using the PCS 10. If the energy storage system 1 has suffered an error however, the manual switch 40 is switched on by, for example, a manager (operation S11) and power from the grid 3 is supplied to the drive load 4 via a power supply path of manual switch 40 (operation S12).

As such, if the energy storage system 1 has an error and thus may not supply power from the grid 3 to the load 4, an additional power supply path from the grid 3 to the load 4 may be formed in parallel and power from the grid 3 may be supplied to the load 4 via the newly formed substitute power supply path, thereby stably supplying power to the load 4.

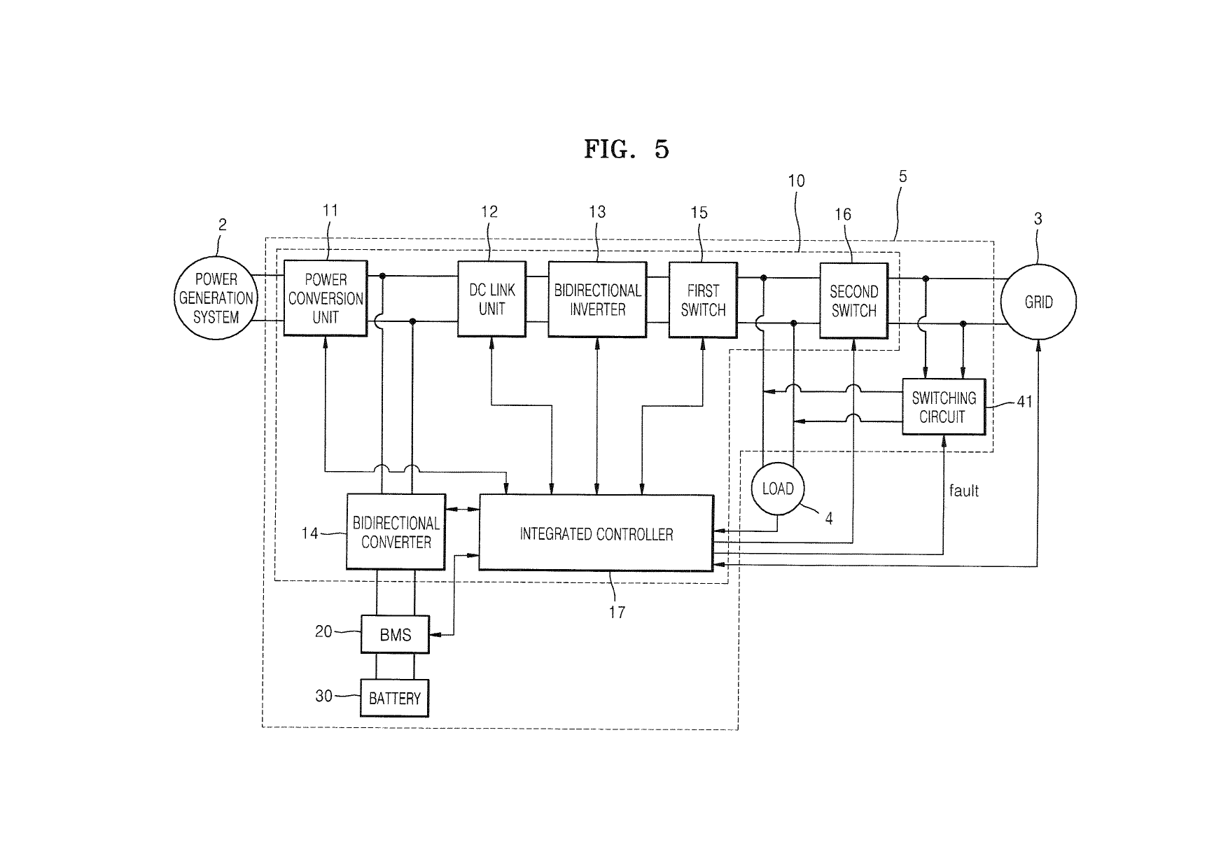

Turning now to FIG. 5, FIG. 5 is a block diagram of an energy storage system 5 according to a second embodiment of the present invention. Since the energy storage system 5 has configurations and functions similar to those of the energy storage system 1 illustrated in FIG. 1, only these differences therebetween will be described.

Referring now to FIG. 5, the energy storage system 5 includes the PCS 10, the BMS 20, the battery 30, and a switching circuit 41. The integrated controller 17 applies to the switching circuit 41 a control signal (fault) for controlling the switching circuit 41. When the PCS 10 is performing in its normal mode of operation, the integrated controller 17 generates as a control signal (fault) which is a signal for blocking a power supply path from the grid 3 to the load 4 through the switching circuit 41. On the other hand, when the PCS 10 does not operate normally, the integrated controller 17 generates as the control signal (fault) a signal for forming a power supply path from the grid 3 to the load 4 through the switching circuit 41. For example, when the switching circuit 41 is a field effect transistor (FET), the integrated controller 17 may generate as the control signal (fault) a high or a low level signal for controlling the on and off electrically conducting states of the FET. Alternatively, when the switching circuit 41 is a relay, the integrated controller 17 may generate as the control signal (fault) a signal for controlling the on and off electrically conducting states of the relay.

The switching circuit 41 allows or blocks power supplied from the grid 3 to the load 4. The switching circuit 41 is electrically connected in parallel to the second switch 16 to allow the transmission of electrical power supplied from the grid 3 to the load 4 via either the second switch 16 or the switching circuit 41. When the PCS 10 operates normally, the switching circuit 41 is switched off (that is, to an open electrical state of operation) according to a control signal (fault) applied from the integrated controller 17 so that power from the grid 3 is supplied to the load 4 via the second switch 16. When the PCS 10 does not operate normally while the grid 3, the PCS 10, and the load 4 are connected in series, power from the grid 3 may not be supplied to the load 4. Accordingly, in this case, the control signal (fault) applied by the integrated controller 17 is a signal for switching the switching circuit 41 to an electrically conducting ON state that allows transmission of electrical power from grid 3 through switching circuit 41 to load 4. According to the control signal (fault) applied from the integrated controller 17, the switching circuit 41 is switched to the ON state of electrical conduction to supply power from the grid 3 to the load 4. The switching circuit 41 may be, for example, an FET or a relay.

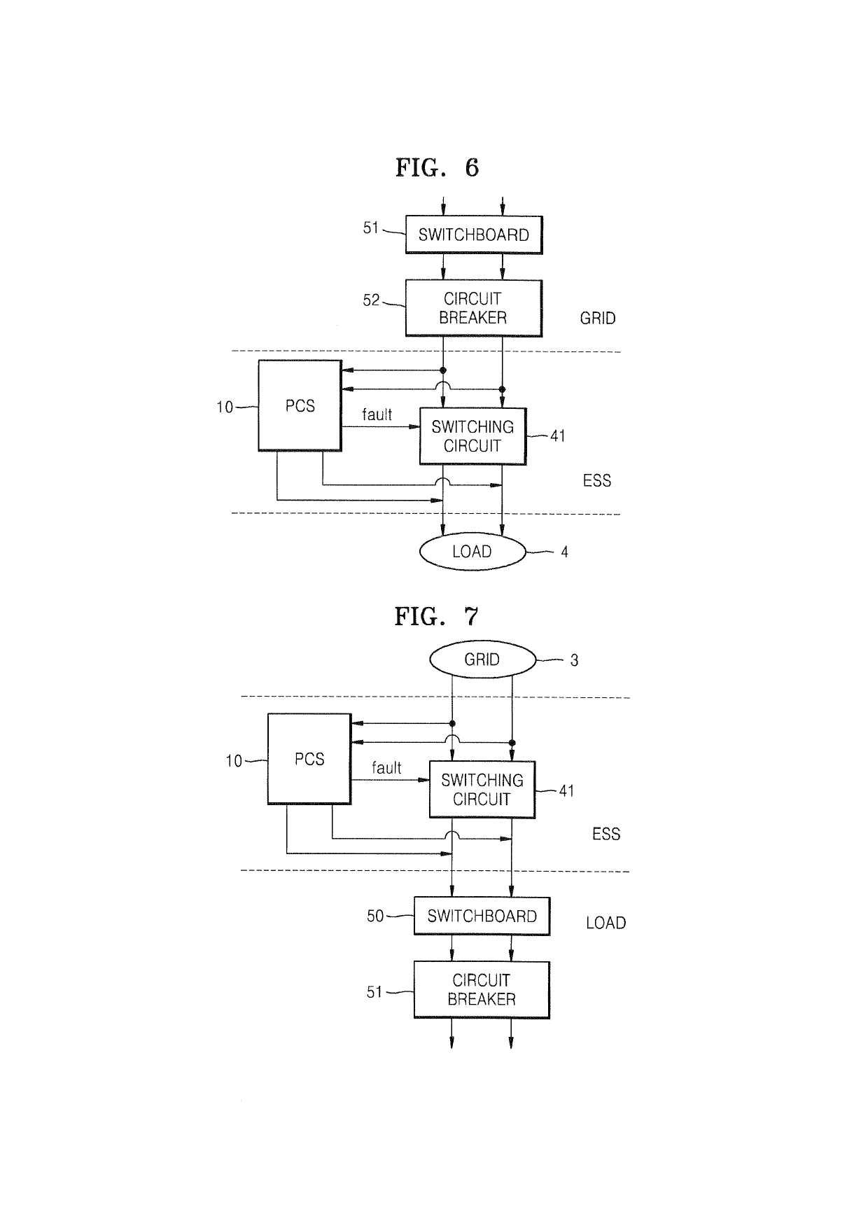

Turning now to FIG. 6, FIG. 6 is a diagram for describing a power supply method of the energy storage system 5 illustrated in FIG. 5, according to the second embodiment of the present invention. Referring to FIG. 6, the PCS 10 and the switching circuit 41 are connected in parallel. In FIG. 6, the PCS 10 and the switching circuit 41 are arranged between circuit breaker 51 and load 4 and are subsequent to switchboard 50 and circuit breaker 51. Here, the switchboard 50 and the circuit breaker 51 are included in the grid 3.

Power passed through the circuit breaker 51 is commonly applied to the PCS 10 and the switching circuit 41. When the PCS 10 operates normally however, power output from the PCS 10 is supplied to the load 4. On the other hand, when the PCS 10 is broken and thus does not operate normally, power output from the switching circuit 41 is supplied to the load 4. In this embodiment, the switching circuit 41 is automatically switched to an ON state of power transmission or to an OFF state of open circuit in conformance with a control signal (fault) generated by the integrated controller 17 of PCS 10 and applied to the switching circuit 41.

Turning now to FIG. 7, FIG. 7 is a diagram for describing a power supply method of the energy storage system 5 illustrated in FIG. 5, according to the second embodiment of the present invention. Referring to FIG. 7, the PCS 10 and the switching circuit 41 are also connected in parallel. In FIG. 7, the PCS 10 and the switching circuit 41 are located between grid 3 and switchboard 50, and prior to the switchboard 50 and the circuit breaker 51. Here, the switchboard 50 and the circuit breaker 51 are included in the load 4.

Power supplied from the grid 3 is commonly applied to input terminals of the PCS 10 and the switching circuit 41. When the PCS 10 operates normally however, power output from the PCS 10 is supplied to the load 4. On the other hand, when the PCS 10 is broken and thus does not operate normally, power output from the switching circuit 41 is supplied to the load 4. In this embodiment, the switching circuit 41 is automatically switched to an ON state of power transmission or to an OFF state of open circuit in conformance with a control signal (fault) generated by the PCS 10 and applied to the switching circuit 41. Power output from the PCS 10 or the switching circuit 41 is sequentially applied to the switchboard 50 and the circuit breaker 51 included in the load 4, and power output from the circuit breaker 51 is ultimately supplied to the load 4.

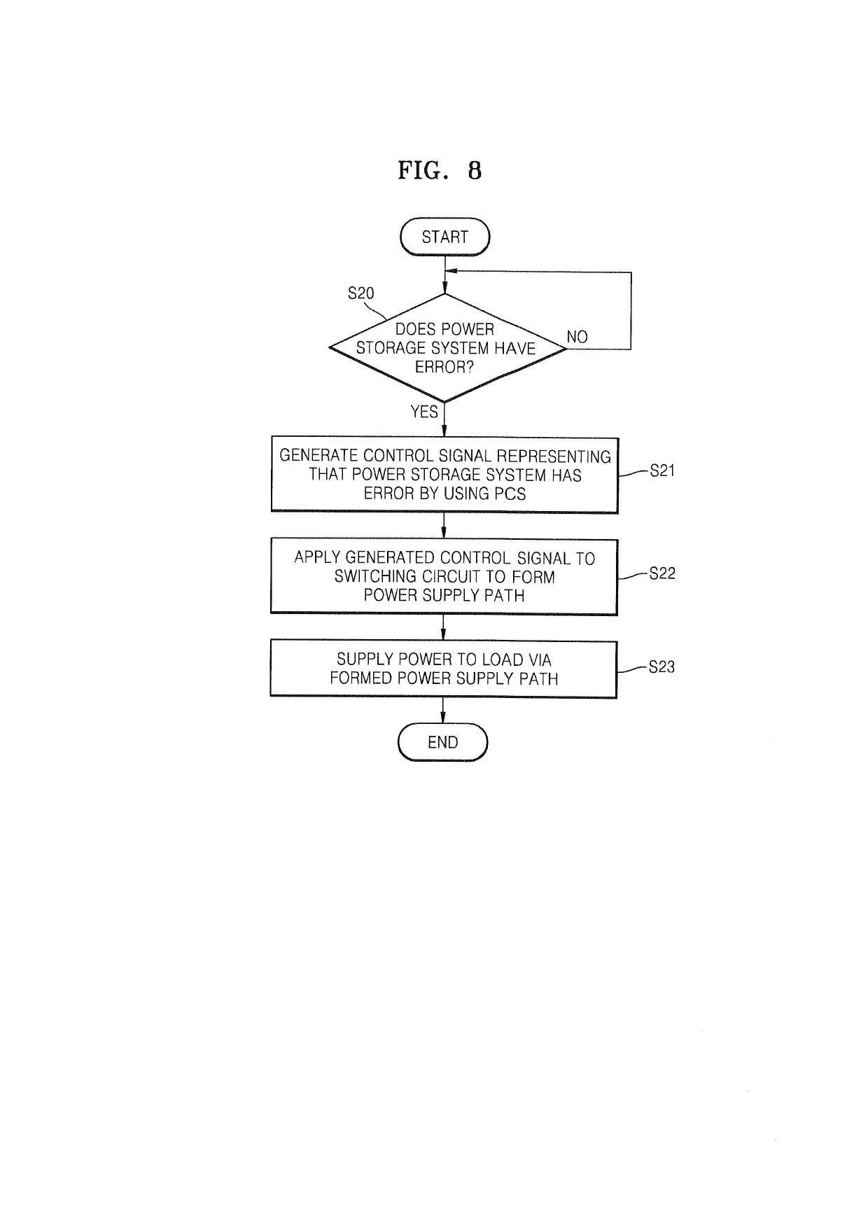

Turning now to FIG. 8, FIG. 8 is a flowchart of a power supply method of the energy storage system 5 illustrated in FIG. 5 according to the second embodiment of the present invention. Referring now to FIG. 8, the energy storage system 5 supplies power from the grid 3 to the load 4. Then, a determination is made in real time by integrated controller 17 whether the energy storage system 5 has an error (operation S20).

When the energy storage system 5 does not have an error, the energy storage system 5 continuously supplies required power to the load 4 by using the PCS 10. When the energy storage system 5 has an error, however, the PCS 10 generates a control signal (fault) representing that the energy storage system 5 has an error (operation S21). The PCS 10 applies the generated control signal (fault) to the switching circuit 41 to form a new power supply path for supplying power from the grid 3 to the load 4 (operation S22). That is, the switching circuit 41 is switched on. After the power supply path is formed according to the control signal (fault), power of the grid 3 is supplied to the load 4 via the formed power supply path (operation S23).

As such, when the energy storage system 5 has an error and thus may not supply power from the grid 3 to the load 4, an additional power supply path from the grid 3 to the load 4 may be formed in parallel and power of the grid 3 may be supplied to the load 4 via the formed power supply path, thereby stably supplying power to the load 4.

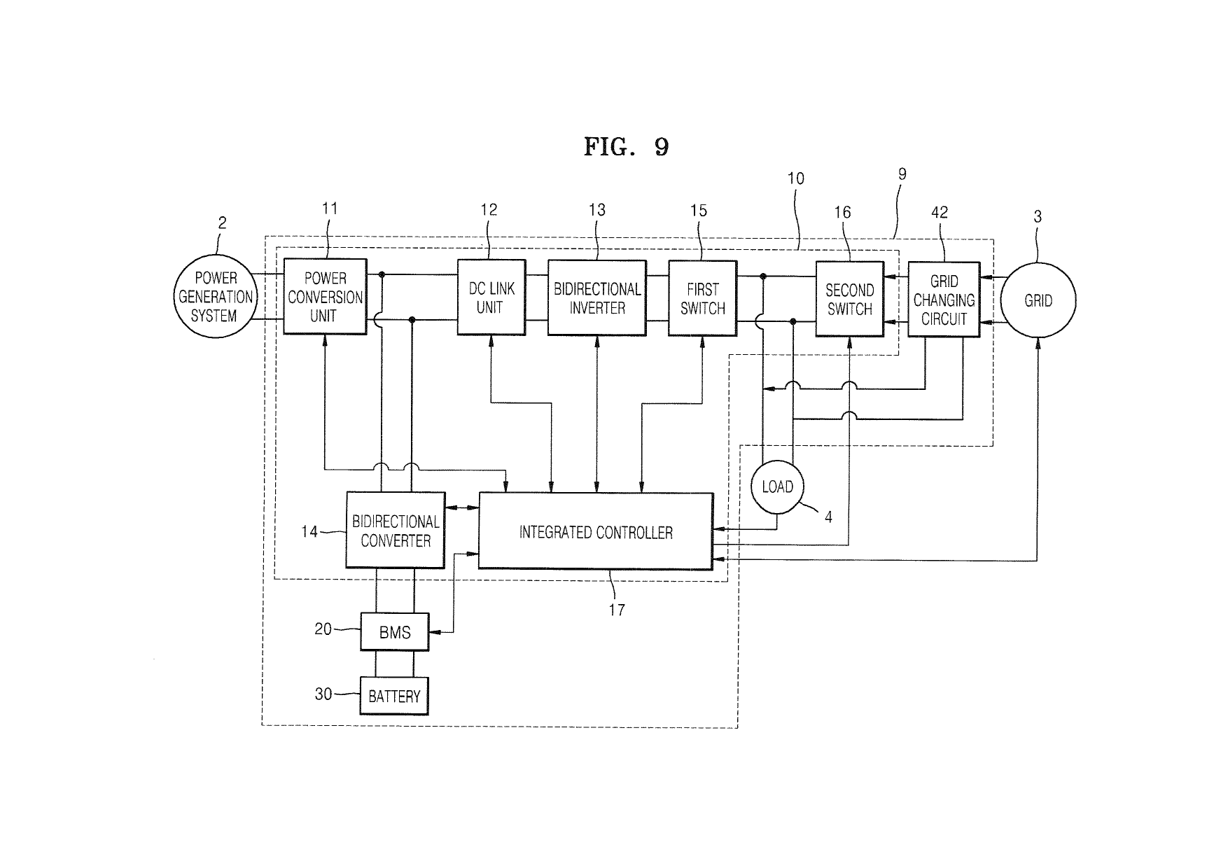

Turning now to FIG. 9, FIG. 9 is a block diagram of an energy storage system 9 according to a third embodiment of the present invention. Since the energy storage system 9 has configurations and functions similar to those of the energy storage system 1 illustrated in FIG. 1, only differences therebetween will be described.

Referring now to FIG. 9, the energy storage system 9 includes the PCS 10, the BMS 20, the battery 30, and a path changing circuit 42. The path changing circuit 42 is connected in series between the second switch 16 and the terminals of grid 3. The path changing circuit 42 receives power from the grid 3 and selectively outputs the received power to a first set of output terminals connected to the second switch 16 or a second output terminal connected to the load 4. In this embodiment, when the PCS 10 operates normally, the path changing circuit 42 outputs the power supplied from the grid 3 to the second switch 16 via the first set of output terminals. On the other hand, when the PCS 10 does not operate normally, the path changing circuit 42 outputs the power supplied from the grid 3 to the load 4 via the second set of output terminals.

Like the manual switch 40 illustrated in FIG. 1, the path changing circuit 42 may be a physical switch for changing a power supply path. Alternatively, like the switching circuit 41 illustrated in FIG. 5, the path changing circuit 42 may be an FET or a relay for automatically changing a power supply path according to a signal generated by the integrated controller 17. The path changing circuit 42 is not limited thereto, however, and may be any of various elements for outputting supplied power to only one of two paths.

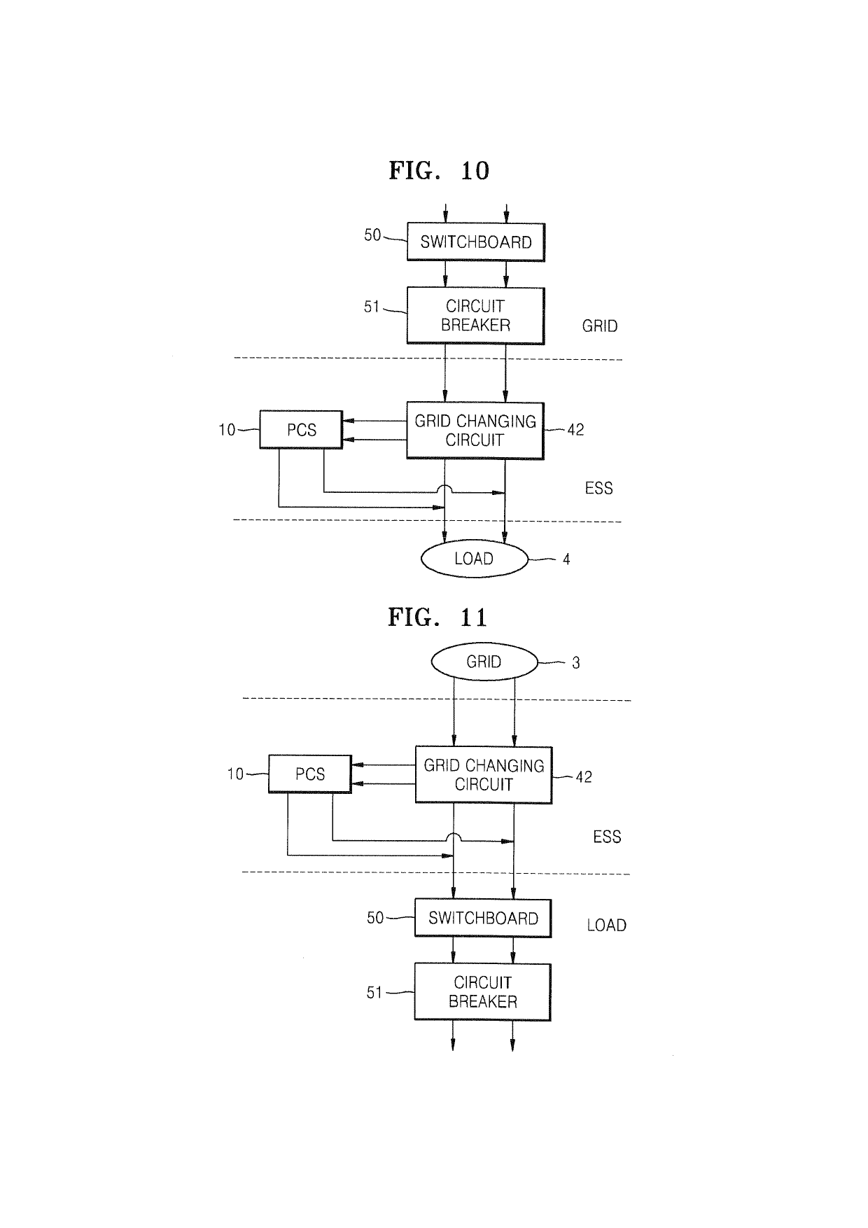

Turning now to FIG. 10, FIG. 10 is a diagram for describing a power supply method of the energy storage system 9 illustrated in FIG. 9 according to the third embodiment of the present invention. Referring to FIG. 10, the PCS 10 and the path changing circuit 42 are connected in series to each other and are arranged between the circuit breaker 51 and the load, and are subsequent to the switchboard 50 and the circuit breaker 51. Here, the switchboard 50 and the circuit breaker 51 are included in the grid 3.

In FIG. 10, power supplied from the grid 3 is applied to the path changing circuit 42. The path changing circuit 42 includes parallel power supply paths for outputting supplied power, and the power supply paths are connected to the outside of the path changing circuit 42 via the first set of output terminals and the second set of output terminals.

In this case, when the PCS 10 operates normally, the path changing circuit 42 outputs the supplied power to second switch 16 of the PCS 10 via the first set of output terminals and second switch 16 of the PCS 10 supplies the power output from the path changing circuit 42 to the load 4. On the other hand, when the PCS 10 is broken and thus does not operate normally, the path changing circuit 42 outputs the supplied power directly to the load 4 via the second set of output terminals.

In this embodiment, the power supply path of the power changing circuit 42 may be automatically changed according to a control signal (fault) applied form the integrated controller 17, or may be manually changed by a user or a manager.

Turning now to FIG. 11, FIG. 11 is a diagram for describing a power supply method of the energy storage system 9 illustrated in FIG. 9 according to the third embodiment of the present invention. Referring now to FIG. 11, the PCS 10 and the path changing circuit 42 are connected in series to each other and are arranged between the grid 3 and the switchboard 50, and are prior to the switchboard 50 and the circuit breaker 51. Here, the switchboard 50 and the circuit breaker 51 are included in the load 4. The power supply method of FIG. 11 is substantially the same as the power supply method illustrated in FIG. 10 and thus detail descriptions thereof will not be provided here.

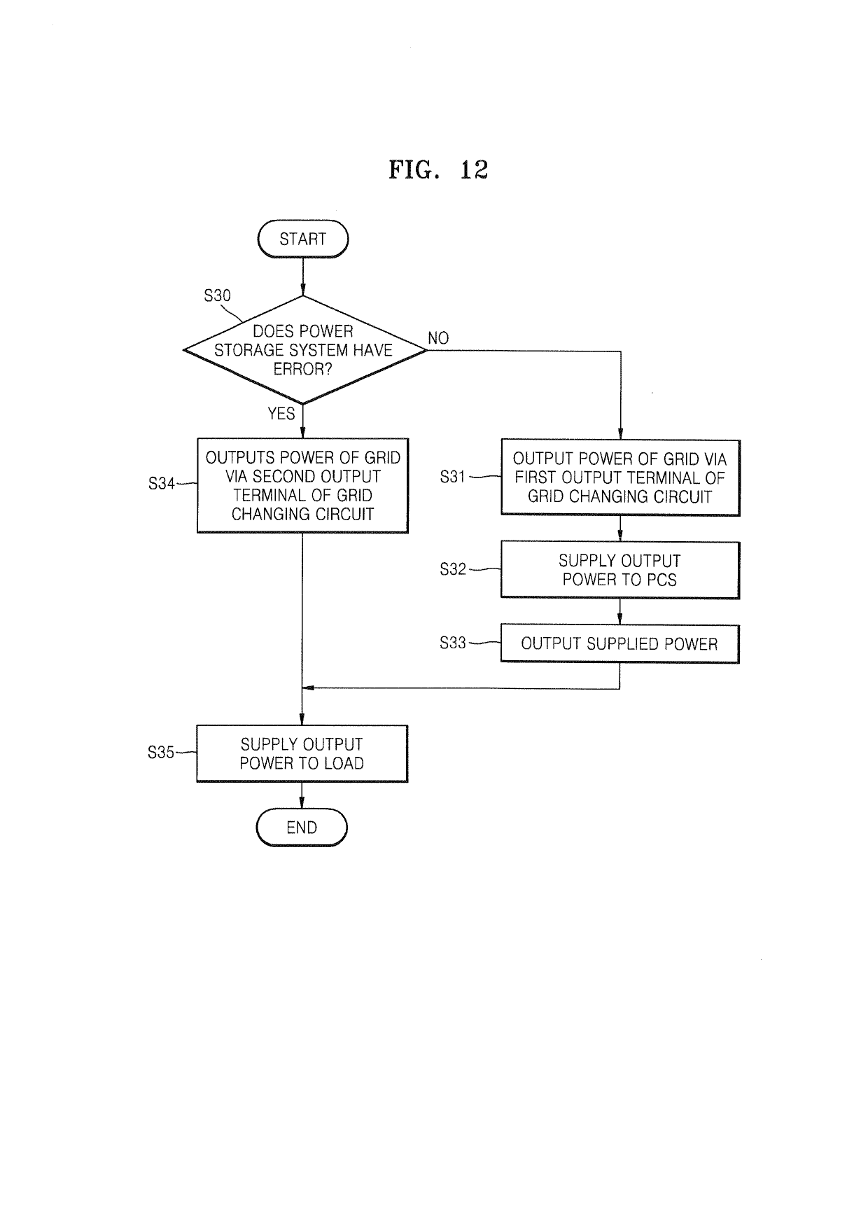

Turning now to FIG. 12, FIG. 12 is a flowchart of a power supply method of the energy storage system 9 illustrated in FIG. 9 according to the third embodiment of the present invention. Referring now to FIG. 12, the path changing circuit 42 receives power from the grid 3 and supplies the received power to the load 4 via the PCS 10. Then, a determination is made in real time whether the energy storage system 9 has an error (operation S30).

When the energy storage system 9 does not have an error, the path changing circuit 42 outputs power from the grid 3 via the first set of output terminals (operation S31), and supplies the output power to the second switch 16 of the PCS 10 (operation S32), and the PCS 10 outputs the supplied power via the second switch 16 (operation S33). The output power is supplied to the load 4 (operation S35).

On the other hand, when the energy storage system 9 has an error, the path changing circuit 42 outputs power of the grid 3 via the second set of output terminals (operation S34), and directly supplies the output power to the load 4 (operation S35). As such, when the energy storage system 9 has an error and thus can not supply power of the grid 3 to the load 4, a substitute power supply path from the grid 3 to the load 4 may be formed in parallel and power from the grid 3 can be supplied to the load 4 via the substitute power supply path, thereby stably supplying power to the load 4.

It should be understood that the exemplary embodiments described therein should be considered in a descriptive sense only and not for purposes of limitation. Descriptions of features or aspects within each embodiment should typically be considered as available for other similar features or aspects in other embodiments.

1. An energy storage system, comprising:
a power conversion system adapted to transmit and receive electric power to and from an external power grid and to relay said electric power received from said external power grid to an electric load via a first path; and
a bypass switch arranged to provide a second and different path to relay power received from said external power grid to said electric load.

2. The energy storage system of claim 1, the bypass switch being arranged in parallel to said power conversion system.

3. The energy storage system of claim 1, the power conversion system comprising a first switch along said first path, said received electric power being relayed to said electric load via said second path when said first switch blocks said first path.

4. The energy storage system of claim 1, the power conversion system comprising an integrated controller to monitor operational states of the power conversion system, the integrated controller to control ON and OFF states of the bypass switch based on the monitored operational states.

5. The energy storage system of claim 1, the bypass switch being a manual switch.

6. The energy storage system of claim 3, the power conversion system comprising an integrated controller to monitor operational states of the power conversion system, the integrated controller to alternately place the first switch in an ON state while the bypass switch is in an OFF state, and to place the first switch in an OFF state while the bypass switch is in an ON state based on the monitored operational states.

7. The energy storage system of claim 1, the bypass switch being arranged in series with the power conversion system and being a path changing circuit adapted to transmit power received from said external power grid along said first path or said second path based on an operational state of the first switch.

8. The energy storage system of claim 1, when the bypass switch does not receive any signal from the integrated controller, the bypass switch reverts to an ON state.

9. The energy storage system of claim 1, wherein the external power grid comprises:
a switchboard; and
a circuit breaker between the switchboard and the electric load, said bypass switch and said power conversion system being coupled in parallel between the circuit breaker and the electric load.

10. The energy storage system of claim 1, wherein the electric load comprises:
a switchboard; and
a circuit breaker between the switchboard and the external power grid, said bypass switch and said power conversion system being coupled in parallel between the switchboard and the external power grid.
